(19) United States
(12) Patent Application Publication
(10) Pub. No.: US 2025/0384781 A1
(43) Pub. Date: Dec. 18, 2025

(54) SURFACE AND NEAR-SURFACE INTENT-BASED COLLISION AVOIDANCE

(71) Applicant: Rockwell Collins, Inc., Cedar Rapids, IA (US)

(72) Inventors: Weston J. Lahr, Sherwood, OR (US); Richard M. Rademaker, Coralville, IA (US); Eric N. Anderson, Marion, IA (US)

(21) Appl. No.: 18/744,447

(22) Filed: Jun. 14, 2024

(51) Int. Cl. G08G 5/04; G08G 5/00; G10L 15/00

(52) U.S. Cl. CPC G08G 5/80; G08G 5/21; G08G 5/723; G10L 15/00

(57) ABSTRACT

An on-aircraft system sends and receives intention data to other aircraft and ground stations. The on-aircraft system then compares the intention data to actual observations and makes predictions about future locations of the other aircraft at any given time. The system may apply confidence metrics to the predicted future locations. The application of intention data and confidence metrics enables high true-positive detection (sensitivity) and low false-positive detection (specificity) of possible imminent collisions.

### BACKGROUND

Runway incursions can lead to near-misses or catastrophic accidents. Airports are areas of densely packed aircraft, with regular movement near runways. Reliably predicting when an aircraft will enter a runway is difficult. With ADS-B and / or sensor observations of other aircraft, predicting collisions based on only position and velocity extrapolation are too unreliable in the tight confines of airport taxiways to provide a low enough rate of false alerts.

It would be highly advantageous to know if aircraft near a runway are likely to incur on the runway while another aircraft is accelerating down the runway. Also, it would be advantageous to predict aircraft and vehicle movements during taxing to avoid other aircraft, buildings, vehicles, hazards, etc.

### SUMMARY

In one aspect, embodiments of the inventive concepts disclosed herein are directed to an on-aircraft system that sends and receives intention data to other aircraft and ground stations. The on-aircraft system then compares the intention data to actual observations and makes predictions about future locations of the other aircraft at any given time.

In a further aspect, the system may apply confidence metrics to the predicted future locations. The application of intention data and confidence metrics enables high true-positive detection (sensitivity) and low false-positive detection (specificity).

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a system useful for implementing exemplary embodiments;

FIG. 2A shows a graphical representation of an airport according to an exemplary embodiment;

FIG. 2B shows a graphical representation of an airport according to an exemplary embodiment;

FIG. 3 shows a block diagram of a neural network suitable for implementing exemplary embodiments.

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to an on-aircraft system that sends and receives intention data to other aircraft and ground stations. The on-aircraft system then compares the intention data to actual observations and makes predictions about future locations of the other aircraft at any given time. The system may apply confidence metrics to the predicted future locations. The application of intention data and confidence metrics enables high true-positive detection (sensitivity) and low false-positive detection (specificity).

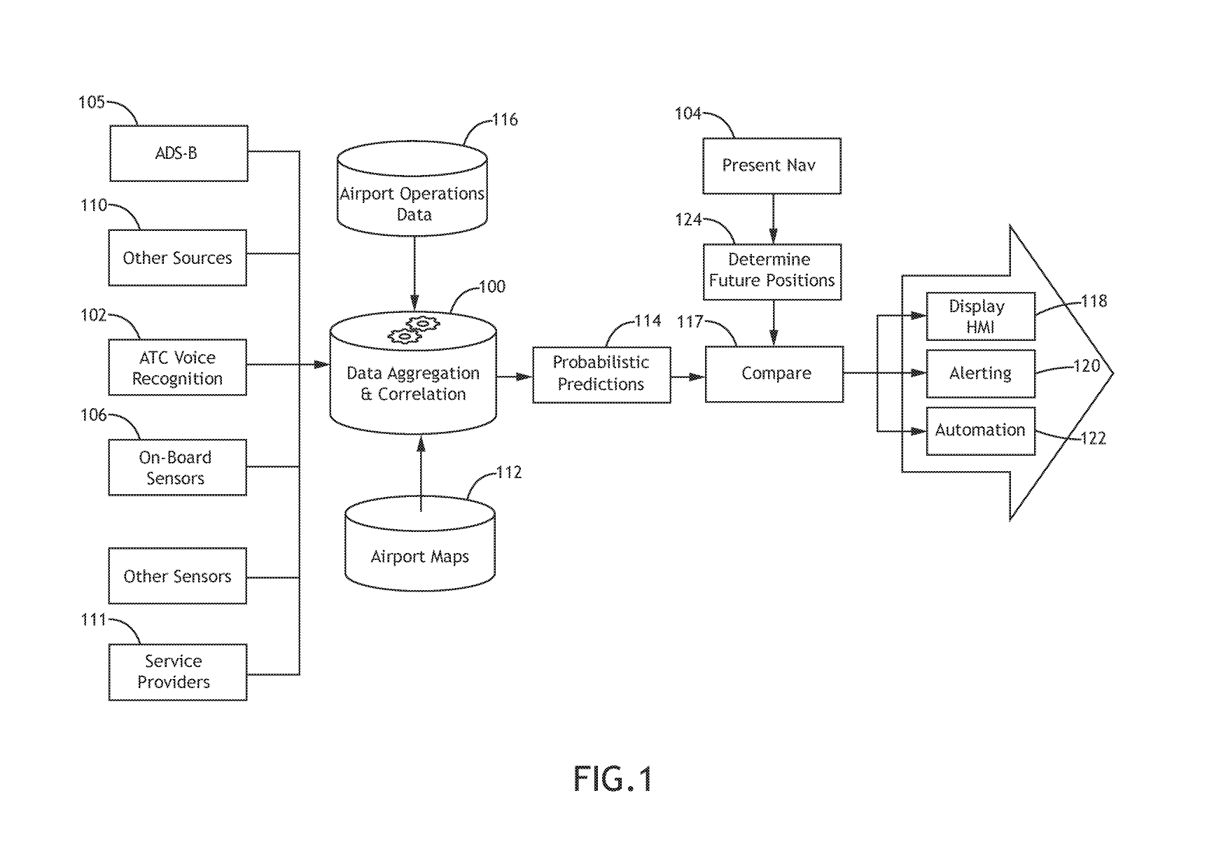

Referring to FIG. 1, a system useful for implementing exemplary embodiments is shown. The system, embodied in a computer processor configured via nontransitory processor executable code, receives / generates present navigation data 104 from a present aircraft (an aircraft including a system according to the present disclosure), including GPS position, rate of movement, a taxi / route plan, etc. Such present navigation data 104 may be used to determine 124 future positions of the present aircraft. In at least one embodiment, the taxi / route plan of the present aircraft may be derived from one or more sources, including but not limited to spoken clearance received over a radio from ground control using voice recognition to identify the route; data-linked clearance provided by ground control; crew announcements of an intended route over radio using voice recognition to identify the route; crew directly entering the route via some user interface; or other source that may include such route data.

The system comprises a data aggregation and correlation element 100 that receives data from a plurality of functions, systems, or other software elements. The data aggregation and correlation element 100 may receive position and speed data (velocity and acceleration) from other aircraft / vehicles; such data may be embodied in ADS-B data packets from an ADS-B system 105, FlightAware, or other sources as described herein. Furthermore, the other aircraft may supply data corresponding to an intended route, including intended taxiways and turns. In at least one embodiment, such intended route data may be embodied in ADS-B data packets, but is not limited to such mechanism. It may be appreciated that existing systems incorporate certain waypoint information into ADS-B data packets while in the air, but such systems are not sufficiently accurate or precise for use on the ground.

In at least one embodiment, the system may receive voice data corresponding to ground control interactions with other aircraft. Voice recognition processes 102 may monitor known ground control channels and identify intended route data from such voice channels, including paths defined by points along taxiways and / or ground intersections. In addition, voice recognition data corresponding to a taxi clearance provided by Air Traffic Control may provide intent information about a corresponding aircraft / vehicle (e.g., a route or trajectory assigned). Furthermore, voice recognition data may provide intent information such as a deviation from the original intended taxi route (e.g., to stop at a holding pad to address an issue), or request to enter the runway at a different point then originally instructed. Alternatively, or in addition, ground control messages may be through datalink rather than voice messages.

Voice data from other aircraft reporting such aircraft’s position may be used to correlate the position and identification of the aircraft with aggregated data and the intended route data to build a confidence metric (does such data match other reported data) that the other aircraft is following the intended route, or flag the other aircraft due to non-confidence.

In at least one embodiment, external service providers 111 may provide information pertaining to flights such as a flight plan, current position, speed, local weather, airport related information, etc. The data aggregation and correlation element 100 may utilize such data to amend, update, verify, etc. data from other sources.

In at least one embodiment, on-board sensors 106 including image sensors may identify and track other aircraft and estimate the position and velocity of the other aircraft. Based on the position and velocity, it may be possible to derive some limited intention of such other aircraft as it pertains to a taxi route.

In at least one embodiment, the on-board sensor 106 may comprise additional sensors such as sensors for identifying a target latitude / longitude, etc., and data sources 110 such as weather radar, flight awareness system, or the like. Furthermore, the data aggregation and correlation element 100 may receive a relevant airport map 112 defined by runways, taxiways, and corresponding intersections. Data from service providers 111 complement the information that is provided by the ADS-B system 105 or by the on-board sensors 106.

For the data aggregation and correlation element 100 to aggregate, it must first correlate based on similarity of the information. For example, the position of a vehicle from the service provider 111 matches the position of the vehicle. The airport map 112 is useful to identify on which airport surface (runway, taxiway, ramp, hold pad) the vehicle is located / operating. All pieces of information can be correlated to build a more complete and correct representation of the current situation.

In at least one embodiment, the system may include a prediction element 114 configured to receive correlated, aggregated data from the data aggregation and correlation element 100. The prediction element 114 may predict where the vehicles will be located in the future based on their aggregated current position, velocity, acceleration (state data) and intended route data. A probability may be associated with each predicted future location.

With the predicted future location / situation of the other vehicle, and the determined future locations of the present aircraft, a monitoring process 117 may compare the predicted future locations of the other vehicle with predicted / determined future locations of the present aircraft based on present navigation data 104. The monitoring process 117 determines if a collision or incursion between a present aircraft (i.e., an aircraft including the present system) and other vehicles is likely to occur.

In at least one embodiment, when certain data is unknown (e.g., a taxi route clearance is unknown), the prediction element 114 may predict the intended route based on observed or known traffic patterns at the airport (e.g., all earlier traffic arriving on a certain runway using the same route to taxi from that runway to the terminal). Such prediction may be an algorithmic weighting of certain identified data points, or a prediction based on a trained neural network or other machine learning techniques. In at least one embodiment, airports may have defined operational patterns; the prediction element 114 may receive airport operations data 116, and use it while predicting future locations. For example, a fuel truck at a given location may imply where the fuel truck is going.

It may be appreciated that extrapolating a future location of other vehicle based on a current position and velocity is likely to result in a large, divergent set of possible future locations (e.g., every location that is physically possible for a given time). The potential for incursion with any one of those extrapolated future locations is likely to result in many “false positives”. By correlating the observed location to a reported intended route, and characterizing the other vehicle by its level of adherence to that intended route, the likelihood of false positives is greatly reduced, improving the reliability and usefulness of the collision avoidance system. Furthermore, in at least one embodiment, the prediction element 114 (or a separate process) may utilize the position, velocity, and acceleration data, in conjunction with data from various sources to produce intention data (where such intention data does not otherwise exist) with greater accuracy than otherwise possible.

In at least one embodiment, data from the data aggregation and correlation element 100, and resulting predicted / determined future locations and comparisons, may be used to generate a visualization on a visual display 118, potentially including a probability that the other vehicles will adhere to the intended route. In addition, the data may be used to produce alerts 120 where the monitoring process determines that the present aircraft exceeds some threshold probability of collision with the intended route of some other vehicle. Likewise, the monitoring process may produce an alert 120 when the present aircraft cannot make a prediction, or the confidence of such prediction falls below some minimum threshold; that is to say, when the present aircraft cannot determine where another vehicle is likely to be, provided some threshold conditions are met. In at least one embodiment, the monitoring process may determine that a lack of data indicates no potentiality, or minimum potentiality, of a collision. The monitoring process may flag “lost aircraft” when observed movement (ADS-B, radar, image sensors, or other sensors) does not match an intended route. The monitoring process or prediction element 114 may then revert to pure position / velocity predictions.

In at least one embodiment, comparisons from the monitoring process may be used to produce automation commands 122 based on the intended routes and probabilities. Such automation may include sending commands to avionics systems, establishing communication with other aircraft or ground control, preparing for a go-around, or the like.

It may be appreciated that while some embodiments are directed toward an on-board system to identify potential conflicts between a present aircraft and one or more of a set of other aircraft, it may be possible to monitor for conflicts between all other traffic within a region where information exists.

In at least one embodiment, the data aggregation and correlation element 100 may be embodied in a system of algorithms or a trained neural network or other machine learning technology. Furthermore, any of the other described functions (e.g., the monitoring processes, alerting processes, probabilistic prediction, etc.) may be embodied in a trained neural network.

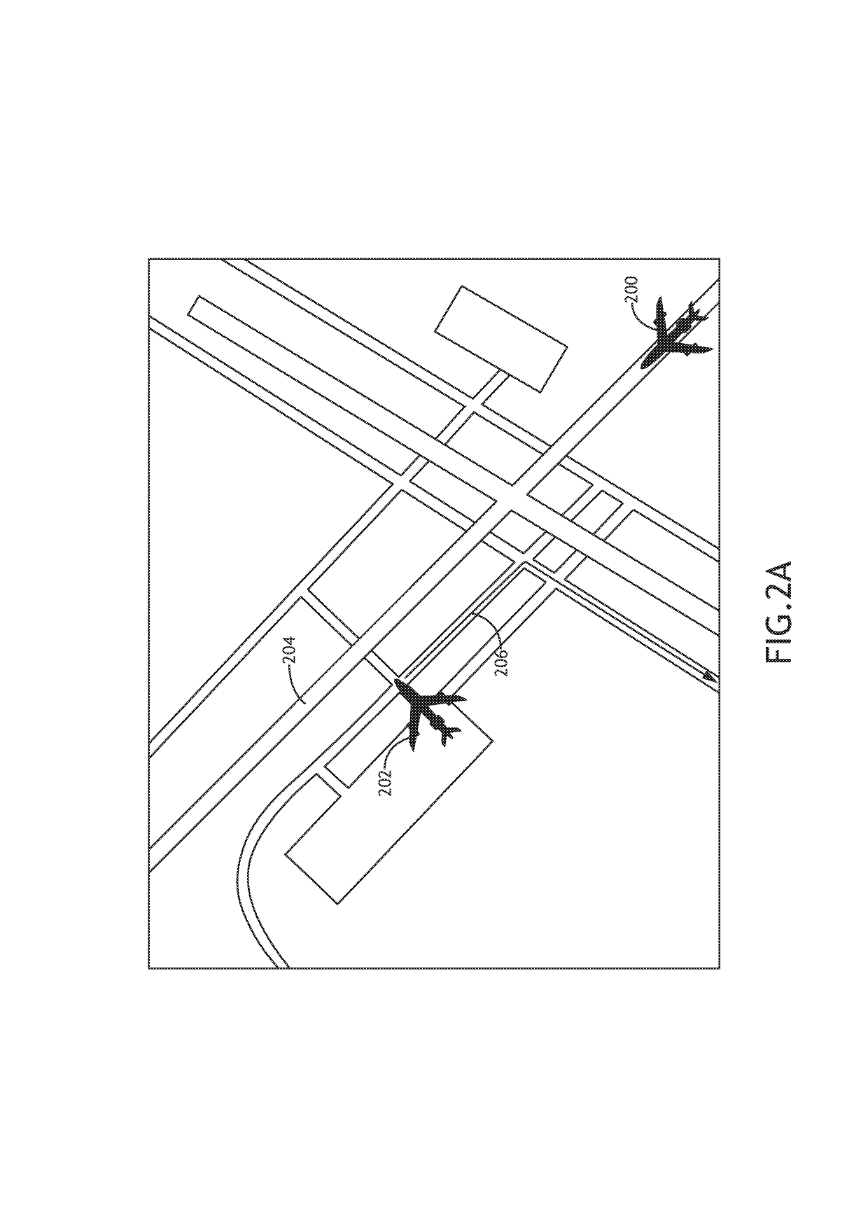

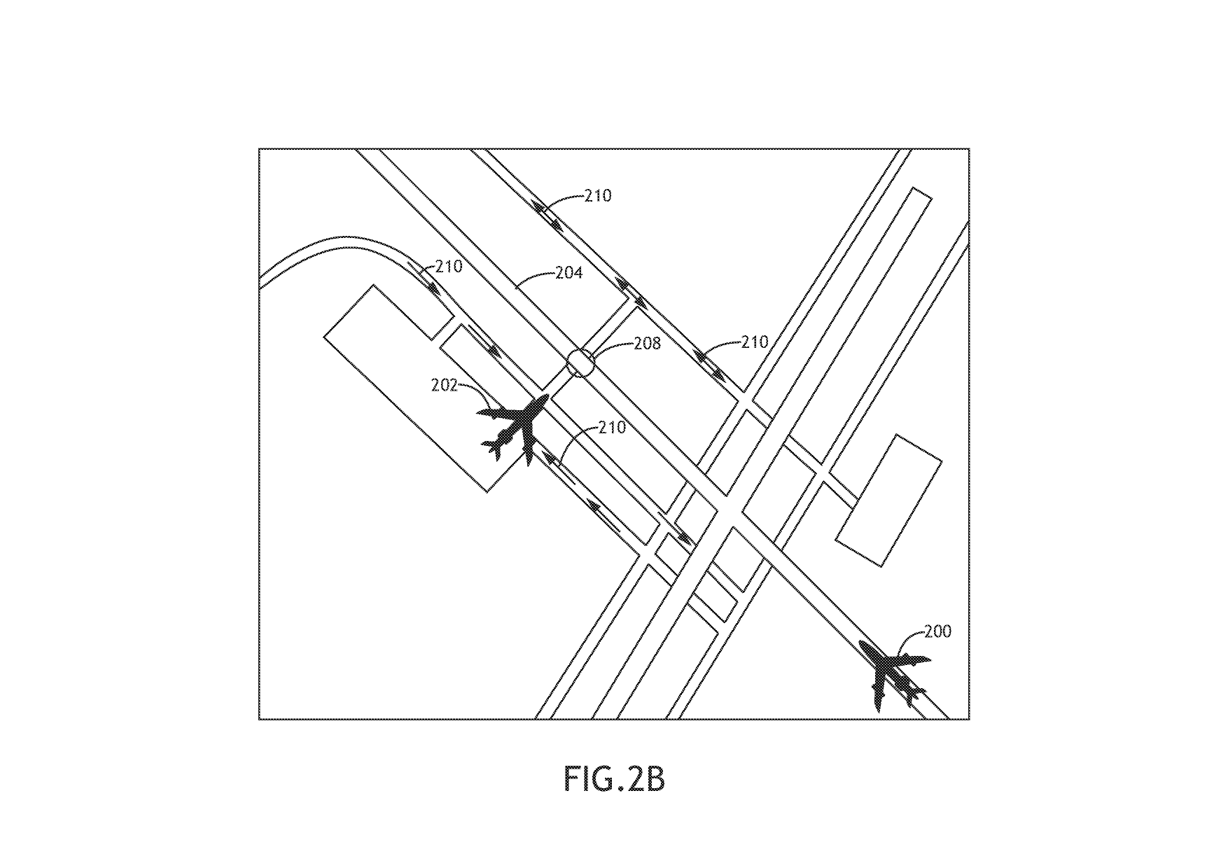

Referring to FIGS. 2A-2B, graphical representations of an airport according to an exemplary embodiment are shown. A present aircraft 200, embodying the present invention, includes a system to make probabilistic intended route predictions for other aircraft 202 on the ground. In a simplistic application, navigation data for the other aircraft 202 (which may be communicated or determined externally) may be used to determine the position and velocity of the other aircraft 202. At any given time, the future location and position of the other aircraft is highly variable because the other aircraft 202 could deviate at any intersection. For example, there is a potential for collision at a point where a taxiway intersects 208 with the present aircraft runway 204. Predicting the future position (or state) based on current state data cannot accurately predict if the other aircraft 202 will actually enter the intersection 208.

In at least one embodiment, the system receives one or more data points corresponding to an intended route 206 of an associated aircraft. Such data points may include spoken clearance for the other aircraft 202 received over the radio from ground control and using voice recognition to extract route; data-linked clearance provided by ground control; ADS-B including the intended taxi route or trajectory; predicted intended route based on monitored airport operations (e.g., by monitoring ADS-B); predicted intended route based on airport operation data provided by service providers such as FlightAware; crew announcement by voice over radio; or intended route directly received through datalink. A prediction process then produces a set of predicted future locations of the other aircraft 202.

In at least one embodiment, where the intended route is based on self-reporting such as ABS-B and / or a taxi clearance as identified via voice recognition, the predicted future locations may be characterized with a level of confidence. Alternatively, if the intended route is derived algorithmically from observation data points, the system may predict an intended route and assign the predicted future locations a different level of confidence. The system may receive data points corresponding to directions of traffic on taxiways (traffic patterns 210). The system then predicts an intended route for those other aircraft for which intended route data does not exist. The traffic patterns 210 and previous traffic tracks are used to estimate / predict which intended route will be taken with some probability. Such estimation / prediction may be by weighted algorithm, trained neural network, other machine learning techniques, or the like.

A monitoring process produces alerts if a predicted future location intersects with a determined future location of the present aircraft 200 based on the known position, velocity, acceleration, and intended route of the present aircraft 200.

Using position, velocity and acceleration data from other aircraft 202, and an intended route, a collision avoidance system according to the present disclosure may produce a better estimation on where the other aircraft 202 is predicted to be in the future by continuously or periodically verifying the intended route against the observed actual position, velocity, and acceleration of the other aircraft 202. The predicted future position may be associated with a confidence metric based on the observations; if the other aircraft 202 is observed adhering to the intended route, the confidence in the predicted future position may be characterized as relatively high, while if the other aircraft is observed deviating from the intended route, the confidence in the predicted future position may be characterized as relatively low. Such confidence metric may be on a scale defined by the magnitude and impact of such deviation (e.g., when the other aircraft makes an unexpected stop, but the position is still on the intended route, the impact on confidence may be relatively small). Furthermore, the confidence in a predicted future position may be impacted if observations from multiple data sources are inconsistent.

In the case a vehicle (other than the present aircraft 200) is not on its cleared taxi route, it may be labeled lost. Likewise, where a vehicle exhibits inconsistent intended route data as compared to ADS-B reporting, the vehicle may be labeled lost. A lost vehicle may not pose a threat to the present aircraft 200 because it is currently located far away from the present aircraft 200 or moving away from the present aircraft 200. In the cases where a vehicle is lost and there is a risk of the vehicle causing an incursion to the present aircraft 200, an alert may be generated to alert a person or automation of this potentially threatening situation. Such risk may be characterized by certain known probability metrics including the last known time, position, and velocity of the other vehicle.

If the confidence metric of the predicted future position is low, there will likely be many future positions possible, with some low probability future positions growing larger over time. When the predicted future position(s) of the other aircraft 202 includes a possibility of incursion with a predicted future position of the present aircraft 200, the collision avoidance system may generate an alert.

It may be appreciated that while specific descriptions provided herein are directed toward predicting future locations of other aircraft 202, the future locations of other ground vehicles (e.g., fuel trucks) may also be predicted and tracked.

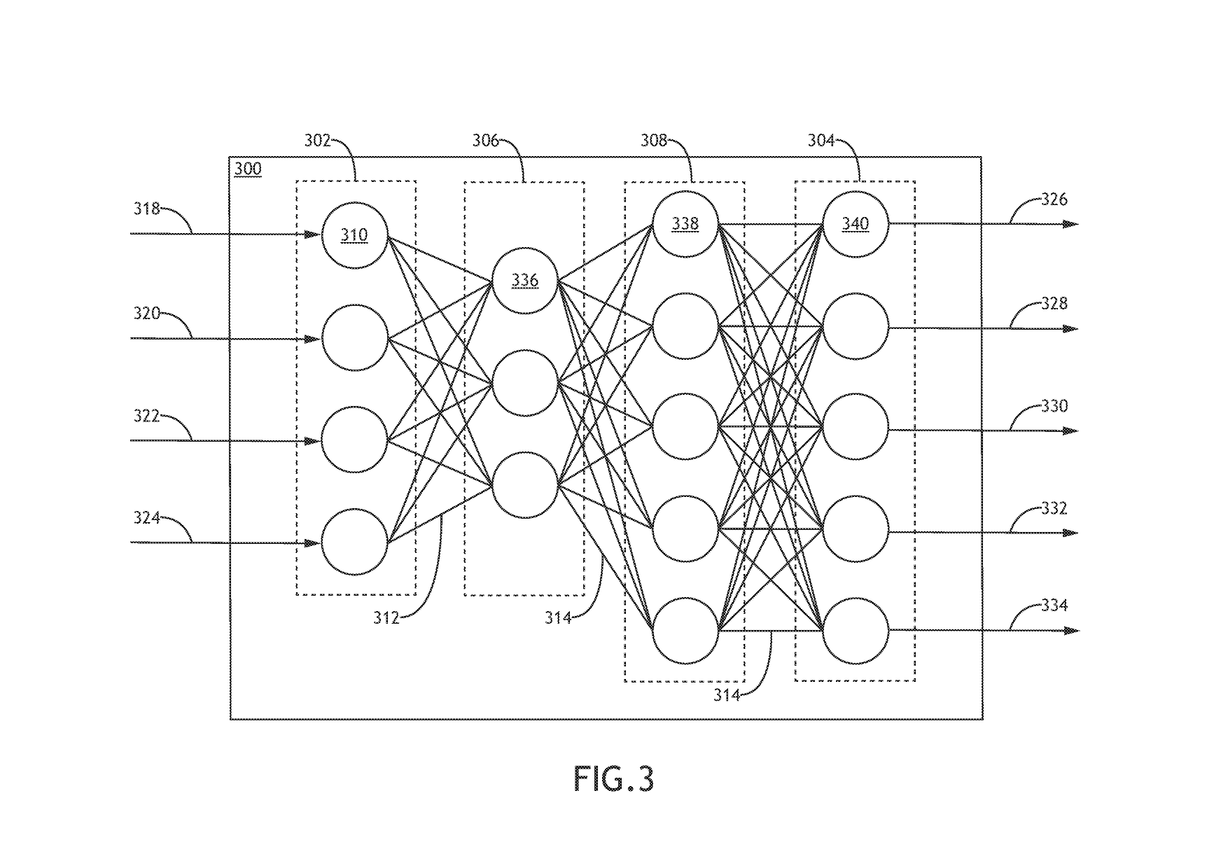

Referring to FIG. 3, a block diagram of a neural network 300 suitable for implementing exemplary embodiments of the inventive concepts disclosed herein is shown. The neural network 300 comprises an input layer 302, and output layer 304, and a plurality of internal layers 306, 308. Each layer comprises a plurality of neurons or nodes 310, 336, 338, 340. In the input layer 302, each node 310 receives one or more inputs 318, 320, 322, 324 corresponding to a digital signal and produces an output 312 based on an activation function unique to each node 310 in the input layer 302. Inputs may correspond to location and velocity data for one or more other aircraft, intention data corresponding to the other aircraft as embodied in a data packet or voice recognition data processed from a ground control channel, image sensor data, radar data, or the like.

An activation function may be a Hyperbolic tangent function, a linear output function, and / or a logistic function, or some combination thereof, and different nodes 310, 336, 338, 340 may utilize different types of activation functions. In at least one embodiment, such activation function comprises the sum of each input multiplied by a synaptic weight. The output 312 may comprise a real value with a defined range or a Boolean value if the activation function surpasses a defined threshold. Such ranges and thresholds may be defined during a training process. Furthermore, the synaptic weights are determined during the training process.

Outputs 312 from each of the nodes 310 in the input layer 302 are passed to each node 336 in a first intermediate layer 306. The process continues through any number of intermediate layers 306, 308 with each intermediate layer node 336, 338 having a unique set of synaptic weights corresponding to each input 312, 314 from the previous intermediate layer 306, 308. It is envisioned that certain intermediate layer nodes 336, 338 may produce a real value with a range while other intermediated layer nodes 336, 338 may produce a Boolean value. Furthermore, it is envisioned that certain intermediate layer nodes 336, 338 may utilize a weighted input summation methodology while others utilize a weighted input product methodology. It is further envisioned that synaptic weight may correspond to bit shifting of the corresponding inputs 312, 314, 316.

An output layer 304 including one or more output nodes 340 receives the outputs 316 from each of the nodes 338 in the previous intermediate layer 308. Each output node 340 produces a final output 326, 328, 330, 332, 334 via processing the previous layer inputs 316. Such outputs may comprise separate components of an interleaved input signal, bits for delivery to a register, or other digital output based on an input signal and DSP algorithm. Outputs may correspond to an intended route of one or more other aircraft, a predicted intended route based on airport operations, one or more predicted future positions, alerts, or automation commands. Furthermore, outputs may define a probability based on data availability, data recency, data sources, and history of actually following the intended route or predicted intended route.

In at least one embodiment, each node 310, 336, 338, 340 in any layer 302, 306, 308, 304 may include a node weight to boost the output value of that node 310, 336, 338, 340 independent of the weighting applied to the output of that node 310, 336, 338, 340 in subsequent layers 304, 306, 308. It may be appreciated that certain synaptic weights may be zero to effectively isolate a node 310, 336, 338, 340 from an input 312, 314, 316, from one or more nodes 310, 336, 338 in a previous layer, or an initial input 318, 320, 322, 324.

In at least one embodiment, the number of processing layers 302, 304, 306, 308 may be constrained at a design phase based on a desired data throughput rate. Furthermore, multiple processors and multiple processing threads may facilitate simultaneous calculations of nodes 310, 336, 338, 340 within each processing layers 302, 304, 306, 308.

Layers 302, 304, 306, 308 may be organized in a feed forward architecture where nodes 310, 336, 338, 340 only receive inputs from the previous layer 302, 304, 306 and deliver outputs only to the immediately subsequent layer 304, 306, 308, or a recurrent architecture, or some combination thereof.

Embodiments of the present disclosure enable communicated intent with observations to focus attention and identify potential hazards based on comparison between an intended route and actual observations to predict future positions. The system generates alerts associated with vehicles behaving oddly.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A computer apparatus comprising:
at least one processor in data communication with a memory storing processor executable code for configuring the at least one processor to:
determine a current location, velocity, acceleration, and route for a present aircraft including the computer apparatus;
determine a future position of the present aircraft based on the current location, velocity, acceleration, and route;
receive position and velocity data for one or more other aircraft, distinct from the present aircraft;
receive intended route data for the one or more other aircraft;
predict a future position of each of the one or more other aircraft based on the intended route data and the corresponding position and velocity data; and
determine if any predicted future position intersects with the future position of the present aircraft.

2. The computer apparatus of claim 1, wherein the intended route data is derived via voice recognition applied to communications between the one or more other aircraft and a ground control.

3. The computer apparatus of claim 1, wherein the at least one processor is further configured to confirm that the one or more other aircraft are adhering to the corresponding intended route data.

4. The computer apparatus of claim 1, wherein the at least one processor is further configured to determine a confidence metric associated with each of the predicted future positions.

5. The computer apparatus of claim 4, wherein each confidence metric is at least partially based on observations of the one or more other aircraft over time.

6. The computer apparatus of claim 1, wherein:
the at least one processor is further configured to receive airport operations data; and
the intended route data is at least partially based on the airport operations data.

7. The computer apparatus of claim 1, wherein the at least one processor is further configured to produce an alert if any predicted future position is determined to intersect with the future position of the present aircraft.

8. A method comprising:
determining a current location, velocity, acceleration, and route for a present aircraft;
determining a future position of the present aircraft based on the current location, velocity, acceleration, and route;
receiving position and velocity data for one or more other aircraft, distinct from the present aircraft;
receiving intended route data for the one or more other aircraft;
predicting a future position of each of the one or more other aircraft based on the intended route data and the corresponding position and velocity data;
determining a confidence metric associated with each predicted future position; and
determining if any predicted future position intersects with the future position of the present aircraft.

9. The method of claim 8, wherein the intended route data is derived via voice recognition applied to communications between the at least one aircraft and a ground control.

10. The method of claim 8, further comprising confirming that the one or more other aircraft are adhering to the corresponding intended route data.

11. The method of claim 8, further comprising receiving airport operations data, wherein the intended route data is at least partially based on the airport operations data.

12. The method of claim 8, wherein each confidence metric is at least partially based on observations of the one or more other aircraft over time.

13. The method of claim 8, wherein the at least one processor is further configured to produce an alert if any predicted future position is determined to intersect with the future position of the present aircraft.

14. An on-aircraft system comprising:
at least one processor in data communication with a memory storing processor executable code for configuring the at least one processor to:
determine a current location, velocity, acceleration, and route for a present aircraft including the computer apparatus;
determine a future position of the present aircraft based on the current location, velocity, acceleration, and route;
receive position and velocity data for one or more other aircraft, distinct from the present aircraft;
receive intended route data for the one or more other aircraft;
predict a future position of each of the one or more other aircraft based on the intended route data and the corresponding position and velocity data; and
determine if the intended route intersects with the route of the present aircraft.

15. The system of claim 14, wherein the intended route data is derived via voice recognition applied to communications between the at least one aircraft and a ground control.

16. The system of claim 14, wherein the at least one processor is further configured to confirm that the one or more other aircraft are adhering to the corresponding intended route data.

17. The system of claim 14, wherein the at least one processor is further configured to determine a confidence metric associated with each predicted future position.

18. The system of claim 17, wherein:
the at least one processor is further configured to receive airport operations data; and
the intended route data is at least partially based on the airport operations data.

19. The system of claim 17, wherein each confidence metric is at least partially based on observations of the one or more other aircraft over time.

20. The system of claim 14, wherein the at least one processor is further configured to produce an alert if any predicted future position is determined to intersect with the future position of the present aircraft.
